(19) United States
(12) Patent Application Publication
(10) Pub. No.: US 2025/0330905 A1
(43) Pub. Date: Oct. 23, 2025

(54) DYNAMIC POWER SAVING MODE ADAPTATIONS FOR WIRELESS ACCESS POINTS

(71) Applicant: QUALCOMM Incorporated, San Diego, CA (US)

(72) Inventors: Ahmed Ragab ELSHERIF, San Jose, CA (US); Sandip HOMCHAUDHURI, San Jose, CA (US); Srinivas KATAR, Fremont, CA (US)

(21) Appl. No.: 18/643,306

(22) Filed: Apr. 23, 2024

(51) Int. Cl. H04W 52/02; H04W 84/12; H04W 88/08

(52) U.S. Cl. CPC H04W 52/0206; H04W 84/12; H04W 88/08

(57) ABSTRACT

This disclosure provides methods, components, devices and systems for dynamic power saving mode adaptations for wireless access points (APs). Some aspects more specifically relate to dynamically enabling or disabling a power saving mode at an AP, adapting the dynamic power saving mode at the AP, or a combination thereof. In some examples, an AP may selectively enable or disable a power saving mode of the AP based on traffic characteristics associated with STAs communicating with the AP or one or more device characteristics associated with the STAs. The AP may then transmit an indication to the STAs of the power saving mode being enabled or disabled at the AP. In some other examples, the AP may monitor uplink transmissions from the STAs while in the power saving mode. The AP may then transmit an indication of a change in parameters of the power saving based on monitoring the uplink transmissions.

### TECHNICAL FIELD

This disclosure relates generally to wireless communication and, more specifically, to dynamic power saving mode adaptations for wireless access points (APs) such a dynamically enabling or disabling a power saving mode, adapting one or more parameters of the power saving mode, or a both.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some WLANs, wireless APs may communicate with one or more STAs within a dynamic power saving mode. In some examples, the dynamic power saving mode may include a listening mode and an active mode. During the listening mode of the dynamic power saving mode, an AP may be associated with limited reception capabilities such that the AP can save power. Further, the AP may switch to the active mode of the dynamic power saving mode where the AP may use the full reception capability of the AP based on receiving a wake-up indication from a STA. Thus, unless a STA transmits the wake-up indication, an AP may remain in the listen mode of the dynamic power saving mode as to save power by using a subset of the reception capabilities of the AP.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method by an access point (AP) is described. The method may include communicating with one or more stations (STAs) via one or more wireless links, selectively enabling or disabling a dynamic power saving mode of the AP based on one or more traffic characteristics associated with the one or more STAs or one or more device characteristics associated with the one or more STAs, and transmitting, to the one or more STAs, an indication of the dynamic power saving mode being enabled or disabled at the AP.

Another innovative aspect of the subject matter described in this disclosure can be implemented in an AP is described. The AP may include a processing system that includes processor circuitry and memory circuitry that stores code. The processing system may be configured to cause the AP to communicate with one or more STAs via one or more wireless links, selectively enable or disable a dynamic power saving mode of the AP based on one or more traffic characteristics associated with the one or more STAs or one or more device characteristics associated with the one or more STAs, and transmit, to the one or more STAs, an indication of the dynamic power saving mode being enabled or disabled at the AP.

Another innovative aspect of the subject matter described in this disclosure can be implemented in an AP is described. The AP may include means for communicating with one or more STAs via one or more wireless links, means for selectively enabling or disabling a dynamic power saving mode of the AP based on one or more traffic characteristics associated with the one or more STAs or one or more device characteristics associated with the one or more STAs, and means for transmitting, to the one or more STAs, an indication of the dynamic power saving mode being enabled or disabled at the AP.

Another innovative aspect of the subject matter described in this disclosure can be implemented in a non-transitory computer-readable medium storing code is described. The code may include instructions executable by one or more processors to communicate with one or more STAs via one or more wireless links, selectively enable or disable a dynamic power saving mode of the AP based on one or more traffic characteristics associated with the one or more STAs or one or more device characteristics associated with the one or more STAs, and transmit, to the one or more STAs, an indication of the dynamic power saving mode being enabled or disabled at the AP.

Some examples of the method, APs, and non-transitory computer-readable medium described herein may further include operations, features, means, or instructions for monitoring one or more uplink transmissions from the one or more STAs, where the one or more traffic characteristics may be based on monitoring the one or more uplink transmissions.

In some examples of the method, APs, and non-transitory computer-readable medium described herein, selectively enabling or disabling the dynamic power saving mode of the AP may include operations, features, means, or instructions for selectively enabling or disabling the dynamic power saving mode according to a power savings metric associated with the dynamic power saving mode based on the one or more traffic characteristics or the one or more device characteristics.

Some examples of the method, APs, and non-transitory computer-readable medium described herein may further include operations, features, means, or instructions for receiving, from the one or more STAs, one or more capability messages associated with the one or more STAs, where selectively enabling or disabling the dynamic power saving mode of the AP may be further based on the one or more capability messages.

One innovative aspect of the subject matter described in this disclosure can be implemented in a method by an AP is described. The method may include communicating with one or more STAs via one or more wireless links in accordance with a dynamic power saving mode, monitoring, while communicating with the one or more STAs in accordance with the dynamic power saving mode, one or more uplink transmissions from the one or more STAs, and transmitting, to the one or more STAs, an indication of a change in one or more parameters of the dynamic power saving mode, the change being based on monitoring the one or more uplink transmissions.

Another innovative aspect of the subject matter described in this disclosure can be implemented in an AP is described. The AP may include a processing system that includes processor circuitry and memory circuitry that stores code. The processing system may be configured to cause the AP to communicate with one or more STAs via one or more wireless links in accordance with a dynamic power saving mode, monitor, while communicating with the one or more STAs in accordance with the dynamic power saving mode, one or more uplink transmissions from the one or more STAs, and transmit, to the one or more STAs, an indication of a change in one or more parameters of the dynamic power saving mode, the change being based on monitoring the one or more uplink transmissions.

Another innovative aspect of the subject matter described in this disclosure can be implemented in an AP is described. The AP may include means for communicating with one or more STAs via one or more wireless links in accordance with a dynamic power saving mode, means for monitoring, while communicating with the one or more STAs in accordance with the dynamic power saving mode, one or more uplink transmissions from the one or more STAs, and means for transmitting, to the one or more STAs, an indication of a change in one or more parameters of the dynamic power saving mode, the change being based on monitoring the one or more uplink transmissions.

Another innovative aspect of the subject matter described in this disclosure can be implemented in a non-transitory computer-readable medium storing code is described. The code may include instructions executable by one or more processors to communicate with one or more STAs via one or more wireless links in accordance with a dynamic power saving mode, monitor, while communicating with the one or more STAs in accordance with the dynamic power saving mode, one or more uplink transmissions from the one or more STAs, and transmit, to the one or more STAs, an indication of a change in one or more parameters of the dynamic power saving mode, the change being based on monitoring the one or more uplink transmissions.

Some examples of the method, APs, and non-transitory computer-readable medium described herein may further include operations, features, means, or instructions for receiving, while in an active mode of the dynamic power saving mode, the one or more uplink transmissions from the one or more STAs, where monitoring the one or more uplink transmissions may be based on the AP being in the active mode of the dynamic power saving mode.

Some examples of the method, APs, and non-transitory computer-readable medium described herein may further include operations, features, means, or instructions for receiving, while in a listen mode of the dynamic power saving mode, the one or more uplink transmissions from the one or more STAs, where monitoring the one or more uplink transmissions may be based on the AP being in the listen mode of the dynamic power saving mode.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports dynamic power saving mode adaptations for wireless access points.

FIG. 3 shows an example of a signaling timeline that supports dynamic power saving mode adaptations for wireless access points.

FIG. 4 shows an example of a process flow that supports dynamic power saving mode adaptations for wireless access points.

FIG. 5 shows an example of a signaling timeline that supports dynamic power saving mode adaptations for wireless access points.

FIG. 6 shows an example of a process flow that supports dynamic power saving mode adaptations for wireless access points.

FIG. 7 shows a block diagram of an example wireless communication device that supports dynamic power saving mode adaptations for wireless access points.

FIGS. 8 and 9 show flowcharts illustrating example processes performable by or at an access point (AP) that supports dynamic power saving mode adaptations for wireless access points.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to dynamic wireless access point (AP) power saving mode operations. Some aspects more specifically relate to dynamically enabling the dynamic power saving mode, disabling the dynamic power saving mode, adapting the dynamic power saving mode, or any combination thereof. In some examples, by dynamically enabling or disabling a power saving mode at an AP or adapting the power saving mode at the AP, the AP may be capable of operating within a power saving mode while refraining from impacting the performance, range, availability, and interoperability of the AP. In some implementations, the AP may dynamically enable or disable the AP power save mode based on traffic characteristics of active STAs and a utility function that calculates an expected power save gain versus the overhead increase that is a result of the AP enabling the power save mode. In some other implementations, the AP may semi-statically enable or disable the AP power saving mode based on receiving one or more capability messages from the STAs connected to the AP indicating whether the one or more STAs are capable of supporting the AP power saving mode. Additionally, or alternatively, the AP may dynamically change the listening mode of the AP power saving mode based on monitoring the uplink traffic during the listening mode, the active mode, or both modes of the AP power saving mode.

Particular aspects of the subject matter described in this disclosure can be implemented to realize one or more of the following potential advantages. In some implementations, dynamically enabling or disabling a power saving mode at the AP may increase the efficiency and decrease the latency of communications by having the power saving mode enabled or disabled based on traffic characteristic, device characteristics, or both. In some other implementations, dynamically adapting the parameters of the power saving mode may allow the AP the capability to ensure relatively high quality and reliable transmissions while maintaining a level of power saving benefit from the power saving mode at the AP. Therefore, the subject matter described in this disclosure may enable an AP to dynamically enable or disable the AP power save mode, dynamically change the parameters of the AP power save mode, or both, without impacting the efficiency, reliability, or robustness of the wireless communications system.

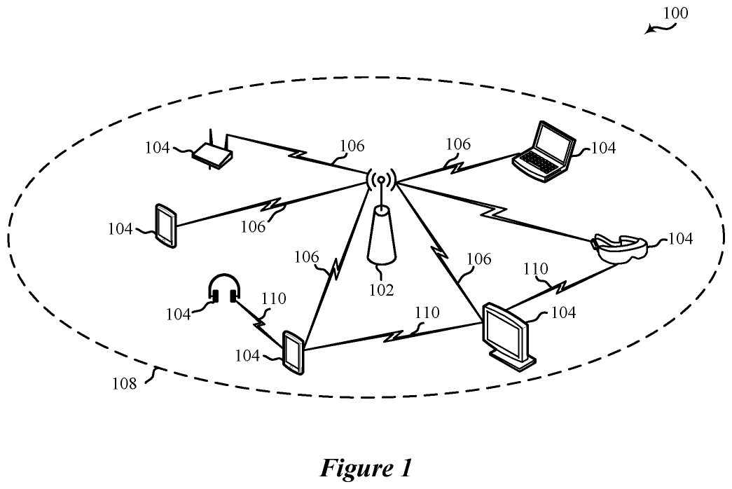

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11 bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some implementations of the wireless communication network 100, to improve the utility and effectiveness of APs 102, an AP 102 may enable a dynamic AP 102 power saving mode. The dynamic AP 102 power saving mode may include a listening mode where the AP 102 listens for and receives communications from STAs 104 using a reduced reception capability and an active mode where the AP listens and receives communications from STAs 104 using the full reception capability of the AP 102. In accordance with the techniques of the present disclosure, an AP 102 may be capable of dynamically enabling or disabling a power saving mode at an AP 102 or adapting the power saving mode at the AP 102, while operating within a power saving mode and while refraining from impacting the performance, range, availability, and interoperability of the AP 102.

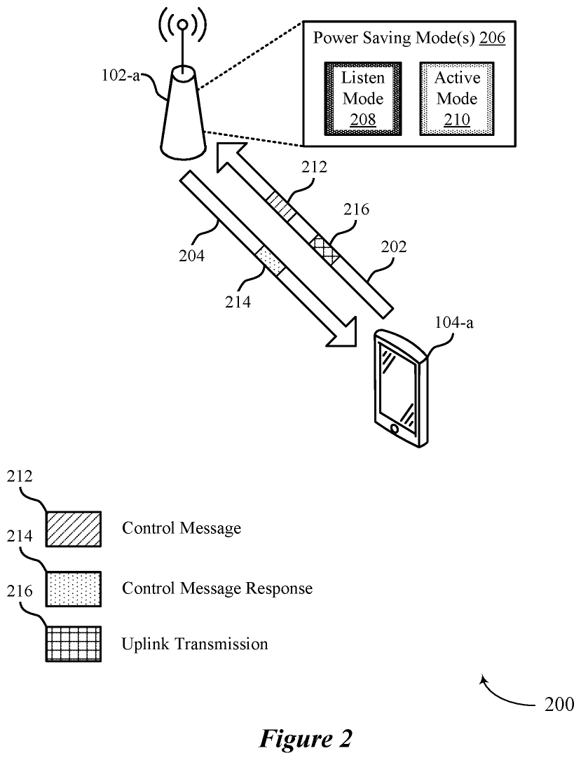

In some implementations, the AP 102 may dynamically enable or disable the AP 102 power save mode based on traffic characteristics of active STAs 104 and a utility function that calculates an expected power save gain versus the overhead increase that is a result of the AP 102 enabling the power save mode. In some other implementations, the AP 102 may semi-statically enable or disable the AP 102 power saving mode based on receiving one or more capability messages from the STAs 104 connected to the AP 102 indicating whether the one or more STAs 104 are capable of supporting the AP 102 power saving mode. Additionally, or alternatively, the AP 102 may dynamically change the listening mode of the AP 102 power saving mode based on monitoring the uplink traffic during the listening mode, the active mode, or both modes of the AP 102 power saving mode. Thus, the techniques of the present disclosure may enable an AP 102 of the wireless communication network 100 the capability of enabling/disabling and adjusting a power saving mode to maintain a level of quality and reliability in communications while operating in the power saving mode to increase the power savings of the AP 102. Further descriptions of the techniques of the present disclosure may be described elsewhere herein, such as with reference to FIGS. 2-6.

FIG. 2 shows an example of a signaling diagram 200 that supports dynamic power saving mode adaptations for wireless access points. The signaling diagram 200 may implement or be implemented to realize one or more aspects of the wireless communication network 100. For example, the signaling diagram 200 illustrates communications between an AP 102-a and a STA 104-a which may be examples of an AP 102 and a STA 104 as illustrated by and described with reference to FIG. 1. In some implementations, the AP 102-a and the STA 104-a may communicate via a first directional communication link 202 from the STA 104-a to the AP 102-a and a second directional communication link 204 from the AP 102-a to the STA 104-a. Further, in some cases, the first directional communication link 202 may be referred to as an uplink communication link and the second directional communication link 204 may be referred to as a downlink communication link. Moreover, the first directional communication link 202 and the second directional communication link 204 may be examples of a communication link 106 as illustrated by and described with reference to FIG. 1.

In some implementations, due to advancements in wireless communication networks (such as the wireless communication network 100 described with reference to FIG. 1), wireless communication networks may include multi-radio APs 102 (such as quad-band APs 102, penta-band APs 102, or both). Multi-radio APs 102 (such as the AP 102-a) may be an example of a type of AP 102 that is associated with multiple transceivers enabling the AP 102 a capability of operating on one or more different frequency bands or channels. For example, if the AP 102-a is a multi-radio AP 102, the AP 102-a may be capable of communication with multiple different wireless devices (such as APs 102, STAs 104, or both) simultaneously. Further, in such implementations, the AP 102-a may consume a relatively high quantity of power while operating in the multi-radio or in an MLO mode. Moreover, some APs 102 (such as the AP 102-a) also may consume relatively high quantities of power due to being connected to relatively large quantities of STAs. Thus, some APs 102 (such as the AP 102-a) may implement AP 102 power saving modes to reduce the power consumption of the AP 102. In some examples, AP 102 power saving modes may be relatively useful due to an increase in APs operating via MLOs and in accordance with multi-radio operations that may result in an increase in power consumption, AP 102 hardware (such as heat-sinks and power adapters) costs, increased carbon footprints of APs 102, stricter power regulatory regulations, and increased soft AP implementations.

To provide power savings at the AP 102-a, the AP 102-a may utilize a power savings mode 206 that includes a listen mode 208 and an active mode 210 that the AP 102-a may dynamically switch between. In some implementations, the periods in which the AP 102-a is in the listen mode 208 of the power savings mode 206 may be referred to as idle periods. For example, during an “idle” period of the listen mode 208, the AP 102-a may operate with limited or reduced reception capabilities (such as 20 MHz, 1 spatial stream, limited MCS, limited PHY modes, or any combination thereof). To switch from the listen mode 208 to the active mode 210 of the power savings mode 206 which may be an example of a full capability mode, the AP 102-a may receive a wake-up indication from a STA 104 connected to the AP 102-a (such as the STA 104-a). In some implementations, the wake-up indications may be similar to a spatial multiplexing power save (SMPS) signals or an enhanced multi-link single radio (eMLSR) signal received by STAs 104. In some implementations, the wake-up indication may be included within a control message 212 or a control frame. For example, the control message 212 may be a RTS or clear to send (CTS) signal, a MU RTS/CTS signal, or another type of initial control frame exchange message that can be used to enable an increase in bandwidth, a quantity of spatial streams, or both for an upcoming transmission opportunity. In response to a wake-up indication with a control message 212, the AP 102-a may transmit a control message response 214 indicating that the AP 102-a has switched from the listen mode 208 to the active mode 210 of the power savings mode 206 at the AP 102-a. In some implementations, the control message 212 also may include padding to ensure that the AP 102-a has enough time to switch from the listen mode 208 to the active mode 210 of the power savings mode 206. For example, the AP 102-a may request that such padding is included to ensure that an uplink transmission 216 from the STA 104-a is received once the AP 102-a has successfully switched between the listen mode 208 and the active mode 210 of the power savings mode 206. In some examples, the AP 102-a may transmit an indication of a duration for the padding along with the indication of the reception capabilities of the AP 102-a associated with the listen mode 208 or via a separate beacon frame.

In some implementations, such short-term changes to the power savings mode 206 of the AP 102-a may impact each STA 104 operating on a respective communication link. For example, once the AP 102-a switches from the listen mode 208 to the active mode 210 of the power savings mode 206, each STA 104 connected to the AP 102-a (such as the STA 104-a) may be capable of communicating with the AP 102-a in accordance with the active mode 210 of the power savings mode 206. Moreover, when the power savings mode 206 is enabled at the AP 102-a, the AP 102-a may remain in the listen mode 208 until the AP 102-a receives the control message 212 that includes a wake-up indication. Further, the AP 102-a may be unable to experience any transmission power savings when operating via the power savings mode 206. Although, the power savings mode 206 may refrain from impacting the transmission performance of the AP 102-a. For example, downlink data transmissions, management message transmissions, control frame transmissions, or any combination may be unimpacted by the power savings mode 206. There also may be a lack of impact to the capability of the AP 102-a to perform active scanning, passive scanning, or both.

To implement or to be capable of enabling the power savings mode 206, the AP 102-a may advertise or broadcast the limited reception capabilities of the AP 102-a (such as the bandwidth being used, a quantity of spatial streams available, an MCS, a PHY mode) while in the listen mode 208 of the power savings mode 206. In some implementations, the AP 102-a may transmit such capabilities within beacons, probe responses, other associated responses, or any combination thereof. Moreover, due to the limited reception capabilities, if the STA 104-a has an uplink transmission 216 packet to transmit, the STA 104-a may be expected to transmit the control message 212 that includes a wake-up condition and receive the control message response 214 indicating a successful mode switch of the power savings mode 206 before transmitting the uplink transmission 216. Additionally, or alternatively, STAs 104 may be unable to support the power savings mode 206 of the AP 102-a. For example, a respective STA 104 may be unable to transmit the control message 212 with the indicated padding due to a power saving mode at the STAs 104 or a lack of communication resources. Thus, for MLOs, the AP 102-a may be “awake” and operate via the full reception capabilities of the AP 102-a on at least one link such that the AP 102-a is capable of serving wireless devices that are unable to support the power savings mode 206. Therefore, the AP 102-a may be capable of using the power savings mode 206 for at least a portion of the communication links connected to the AP 102-a to provide power savings for the AP 102-a. Moreover, the AP 102-a may perform such operations based on at least one wireless device that is connected to the AP 102-a being unable to support the power savings mode 206 or being unable to support transmitting the control message 212 that include the wake-up control frames in a non-high throughput (HT) duplicate format.

In some implementations, the AP 102-a may be capable of updating the capabilities of the listen mode 208 of the power savings mode 206 dynamically via one or more beacons. For example, the AP 102-a may transmit a beacon indicating an update to the reception capabilities (such as bandwidth, quantity of spatial streams, MCS, PHY mode, or any combination thereof) of the AP 102-a while operating within the listen mode 208 of the power savings mode 206. In some examples, the AP 102-a may enable such ability on a respective communication link based on each wireless device (such as client) on the respective communication link that are ultra-high reliability (UHR) devices (such as UHR clients) being capable of receiving a listen mode 208 capability update indication, being capable of supporting transmitting wake-up control frames via the control message 212 in a non-HT duplicate format, or a combination thereof.

However, some APs 102 (such as the AP 102-a) may have additional power save expectations compared to other wireless devices (such as non-AP 102 STAs 104). For example, STAs 104 may expect that if a power savings mode 206 is implemented at the STA 104-a, the performance should remain relatively similar (such as the power savings mode 206 should not result in performance degradation for the STAs 104). Further, if the STA 104-a is associated with stringent quality of service (QoS) requirement such as latency sensitive traffic, the power savings mode 206 should refrain from resulting in a relatively large performance degradation for the STA 104-a. For example, the STA 104 a may be an XR related device that transmits latency sensitive data traffic (such as data traffic with relatively strict packet delay budgets (PDBs)). Thus, if the performance of communications between the AP 102-a and the STA 104-a decreases relatively drastically, the PDBs the latency sensitive traffic (such as XR related traffic) of the STA 104-a may be unable to be satisfied resulting in a decrease in efficiency and reliability in a wireless communication network. Therefore, the AP 102-a may refrain from enabling the power savings mode 206 if such enablement may decrease the performance of communications with the STA 104-a.

Moreover, the AP 102-a may be expected to reachable by clients (such as STAs 104) anywhere within a cell. Thus, the AP 102-a may be expected to consider the impact of reachability of the power savings mode 206 as the AP 102-a should refrain from implementing the power savings mode 206 if the such implementation would limit the ability of the AP 102-a to communicate with STAs 104 at a cell edge. In some implementations, the AP 102-a also may be expected to be available at all times to connected and non-connected wireless devices. For example, the AP 102-a should be capable of allowing each associated device the capability of performing data communications with the AP 102-a regardless of the capabilities of a respective device. Moreover, the AP 102-a should also be capable of allowing non-associated devices (such as STAs 104) the ability to scan and associate with the AP 102-a. Thus, the AP 102-a may have to ensure that such abilities are capable while operating within the power savings mode 206. Additionally, or alternatively, the AP 102-a may ensure that the power savings mode 206 may refrain from resulting in interoperability issues between a respective STA 104 and the AP 102-a. Thus, before enabling the power savings mode 206, the AP 102-a may ensure that each expectation of the AP 102-a is satisfied.

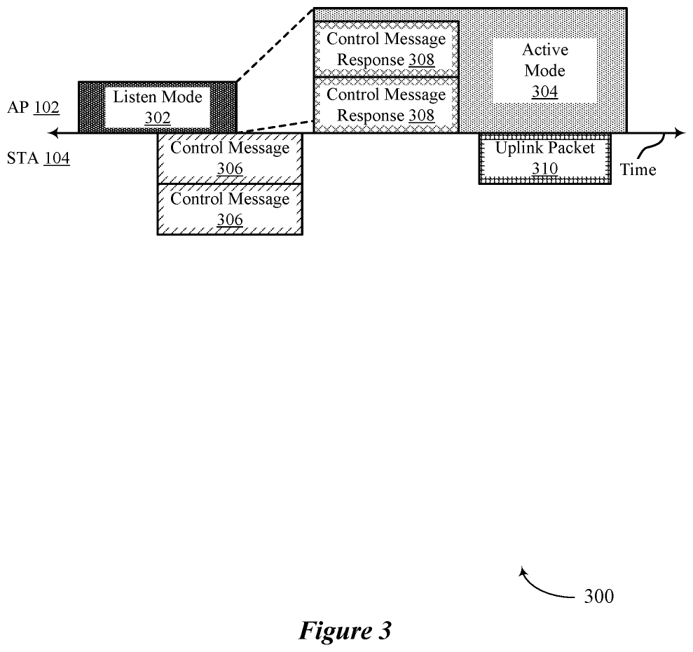

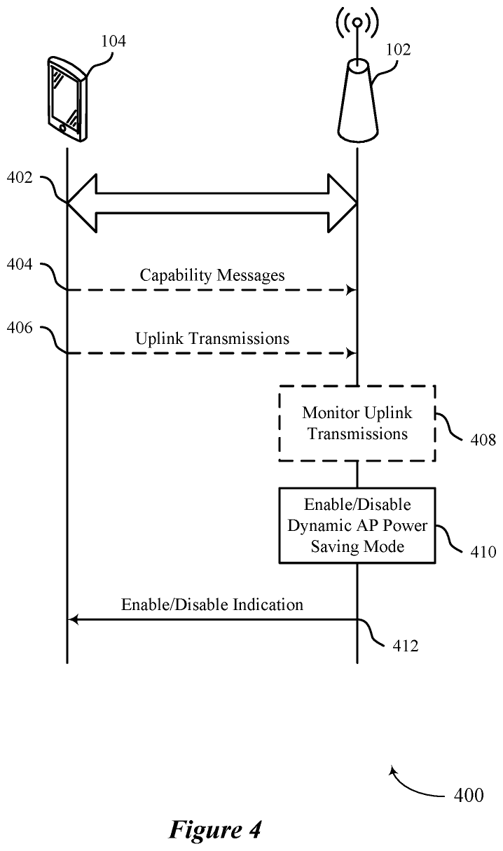

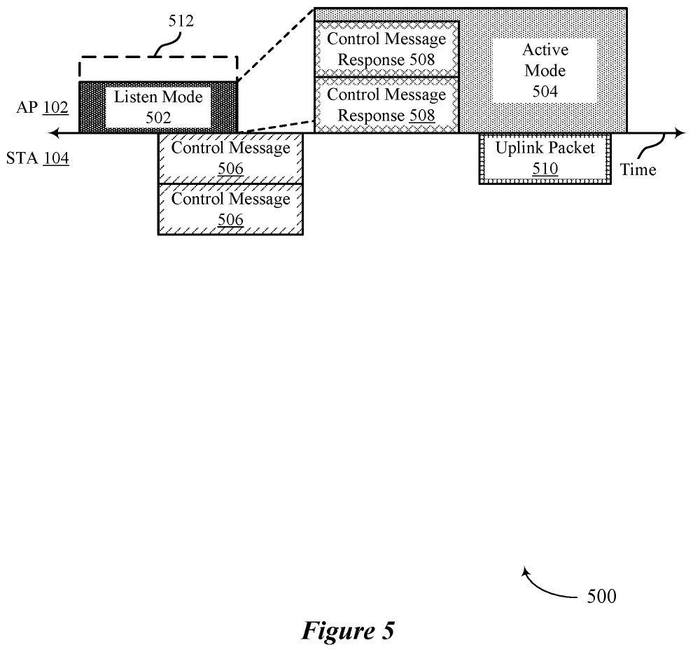

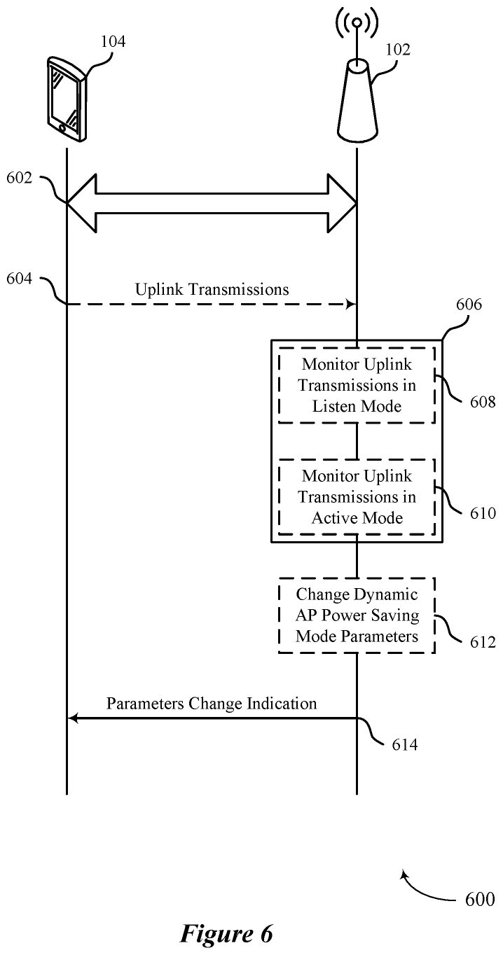

In accordance with the techniques of the present disclosure, the AP 102-a may be capable of enabling or disabling the power savings mode 206 of the AP 102-a to ensure that the performance, range, availability, and interoperability expectations of the AP 102-a are satisfied. Additionally, or alternatively, the techniques of the present disclosure may enable the AP 102-a to reduce the overhead associated with the power savings mode 206. The techniques of the present disclosure also may enable the AP 102-a with the capability of dynamically adapting the listen mode 208 of the power savings mode 206 via STA 104 capability information, traffic characteristics, service level agreement (SLA) expectations versus a power saving benefit (PSB) of the power savings mode 206, or any combination thereof. Further descriptions of the techniques of the present disclosure may be described elsewhere herein, such as with reference to FIGS. 3-6. Moreover, the techniques of the present disclosure may enable the AP 102-a to evaluate the power savings mode 206 as a function of benefit and associated overhead by dynamically determining to enable or disable the power savings mode 206, as described with reference to FIGS. 3 and 4, by dynamically adapting the listen mode 208 of the power savings mode 206, as described with reference to FIGS. 5 and 6, or a combination thereof, while refraining from impacting the performance, range, availability, or interoperability of the AP 102 when operating with the power savings mode 206.

FIG. 3 shows an example of a signaling timeline 300 that supports dynamic power saving mode adaptations for wireless access points. In some examples, the signaling timeline 300 illustrates communications between an AP 102 and a STA 104 as illustrated by and described with reference to FIG. 1. For example, the signaling timeline 300 may illustrate communications between the AP 102 and the STA 104 over a duration or period of time to determine whether to enable or disable a power saving mode at the AP 102.

In some implementations, an AP 102 may implement or utilize a power saving mode that includes a listen mode 302 and an active mode 304 as describe elsewhere herein, such as with reference to FIG. 2. In some examples, the AP 102 may dynamically enable the power saving mode based on one or more traffic characteristics of the STAs 104 connected to the 102 (such as active STAs). For example, the AP 102 may monitor the inter-arrival times of uplink traffic (such as traffic from the connected STAs 104), an average buffer size from a buffer status report (BSR), or both. In some implementations, while communication with the AP 102, the one or more STAs 104 connected to the AP 102 may transmit one or more BSRs to indicate a quantity of data within a buffer (such as waiting to be transmitted) at the one or more STAs 104. Moreover, an inter-arrival time may be an indication of a time between the AP 102 receiving a first data packet and the AP 102 receiving a second data packet In some examples, the AP 102 may monitor both the uplink traffic inter-arrival time and the average buffer size such that both STAs 104 capable of non-triggered uplink access and STAs 104 capable of triggered uplink access can be monitored. Moreover, non-triggered uplink access may be an example of a STA 104 transmitting uplink data without a trigger from an AP 102 and triggered uplink access may be an example of a STA 104 transmitting uplink data in response to a trigger (such as a transmission of a trigger frame) from an AP 102.

As part of the monitoring, the AP 102 may calculate an average uplink traffic inter-arrival time, IAT_{avg}, and the average buffer size, buffer_{avg}, over a fixed or sliding observation window for each STA 104 connected to the AP 102 and over all the STAs 104 connected to the AP 102. Based on the average uplink traffic inter-arrival time and the average buffer size for one or more STAs, the AP 102 may calculate and determine a utility of a quantity of power to be saved if a power saving mode is enabled at the AP 102 based on the associated airtime overhead of enabling the power saving mode, OH_{PS}, via a utility function shown below via Equation 1.

$$Utility ( Dynamic AP PS ) = α * P S B ( I A {T}_{avg} , {buffer}_{avg} ) - β * O {H}_{PS} \qquad ( 1 )$$

As shown in Equation 1, the utility of the enabling a power saving mode at the AP 102, Utility(Dynamic AP PS), may be determined by a product of a first scaling factor, a, and a function, PSB(IAT_{avg}, buffer_{avg}), that translates the average uplink inter-arrival time and the average buffer size into a power saving benefit in milliwatts (mW). Further, the utility of the enabling a power saving mode at the AP 102 also may be determine by a product of a second scaling factor, β, and the overhead associated with enabling the power saving mode, OH_{PS}, which is measured in milliseconds (ms). Moreover, the overhead value may be determined by a sum of a duration of a wake-up control frame with padding (such as a control message 306), a response frame (such as the control message response 308), and twice the duration of the SIFS (such as 2*SIFS).

In some examples, if the average uplink traffic inter-arrival time is relatively low and the average STA 104 buffer size is relatively high, the AP 102 may determine that the transmission of uplink traffic may be relatively frequent. In such examples, the AP 102 may determine to disable a power saving mode at the AP 102. In some other examples, if the average uplink traffic inter-arrival time is relatively high and the average STA 104 buffer size is relatively low, the AP 102 may determine that the transmission of uplink traffic may be relatively infrequent and can determine to enable the power saving mode at the AP 102 accordingly such that the AP 102 can receive an uplink packet 310 within the active mode 304. Additionally, or alternatively, the AP 102 may utilize a utility threshold to determine whether to enable or disable the power saving mode. For example, if the utility of the dynamic power saving mode is above a threshold (such as Utility(Dynamic AP PS)<threshold) the AP 102 may determine that the power saving gain outweighs the overhead associated with enabling the power saving mode. In another example, if the utility of the dynamic power saving mode is below the threshold, the AP 102 may determine that the utility of enabling the power saving mode may be relatively low based on the overhead and latency associated with enabling the power saving mode. In some implementations, the threshold may be set to zero such that the power saving mode may be enabled if the utility of the power saving mode is equivalent to a non-zero integer indicating a positive utility. In some other implementations, the threshold may be set to a non-zero positive integer such that the utility level should be above the threshold level to enable the power saving mode regardless of whether the utility is above zero indicating that enabling the power saving mode would result in some level of power saving at the AP 102. Additionally, or alternatively, the AP 102 may utilize the QoS restrictions of the uplink traffic to determine whether to enable the power saving mode. For example, if a quantity of STAs 104 connected to the AP 102 that are associated with latency-sensitive traffic (such as a transmission of a wake-up frame may result in a decrease in performance) is above a threshold level of STAs 104, the AP 102 may determine to disable the power saving mode to remove the overhead and latency associated with the wake-up sequence. Moreover, when the power saving mode is disabled, the AP 102 may transmit an indication of the disablement to the connected STAs 104 via one or more beacons or management frames.

In some implementations, the AP 102 may semi-statically enable or disable the power saving mode based on associated STA 104 capabilities and link availability. For example, the AP 102 may receive one or more capability messages from the one or more STAs 104 connected to the AP 102. The AP 102 may use the capability information of the one or more capability messages to determine if a respective STA 104 is capable of supporting the power saving mode. In some examples, the AP 102 may enable the power saving mode based on whether each STA 104 connected to the AP 102 is capable of supporting the AP 102 operating in the power saving mode. In some other cases, the AP 102 may determine to enable the power saving mode on a per-link (such as communication link) basis. Thus, the AP 102 may determine to enable the power saving mode on a respective link if each of the devices (such as clients) connected to the AP 102 via the respective link are UHR devices, if each of the devices on the respective link are capable of supporting the power saving mode at the 102 and are capable of supporting transmitting wake-up control frames via a control message 306 in a non-HT duplicate format, and if the AP 102 has one or more other links or radios to support devices that are non-UHR devices and lack such capabilities described herein. Moreover, the AP 102 may enable the power saving mode for a respective communication link if each of the above conditions are satisfied. Additionally, or alternatively, the AP 102 may be expected to perform MLOs if one or more of the devices connected to the AP 102 are non-UHR devices, if one or more of the UHR devices are incapable of supporting the power saving mode, are incapable of transmitting a control message 306 indicating the wake-up frame in the non-HT duplicate format, or both, or any combination thereof.

In some other implementations, the AP 102 may expect the devices (such as the STAs 104) connected to the AP 102 to transmit an RTS or CTS message prior to transmitting an uplink packet 310 that is above a byte threshold. Therefore, by expecting the STAs 104 to transmit the RTS or CTS message, the AP 102 may be able to communicate with and be connected to non-UHR (such as pre-UHR) devices while the power saving mode at the AP 102 is enabled instead of moving them to a separate communication link or disabling the power saving mode. For example, the RTS or CTS message may act as the control message 306 that indicates a wake-up frame and the control message response 308 may indicate a confirmation of the RTS or CTS message to indicate the STA 104 may transmit the uplink packet 310 associated with the RTS or CTS message. Moreover, in such implementations, the AP 102 may be capable of keeping the information associated with the power saving mode transparent to the devices connected to the AP 102. Therefore, the STAs 104 connected may be unaware that the AP 102 is operating via a power saving mode as the AP 102 may configure the associated byte threshold for the transmission of a RTS or CTS message to be such that the AP 102 is capable of receiving transmissions below the byte threshold while in the listen mode 302 of the power saving mode.

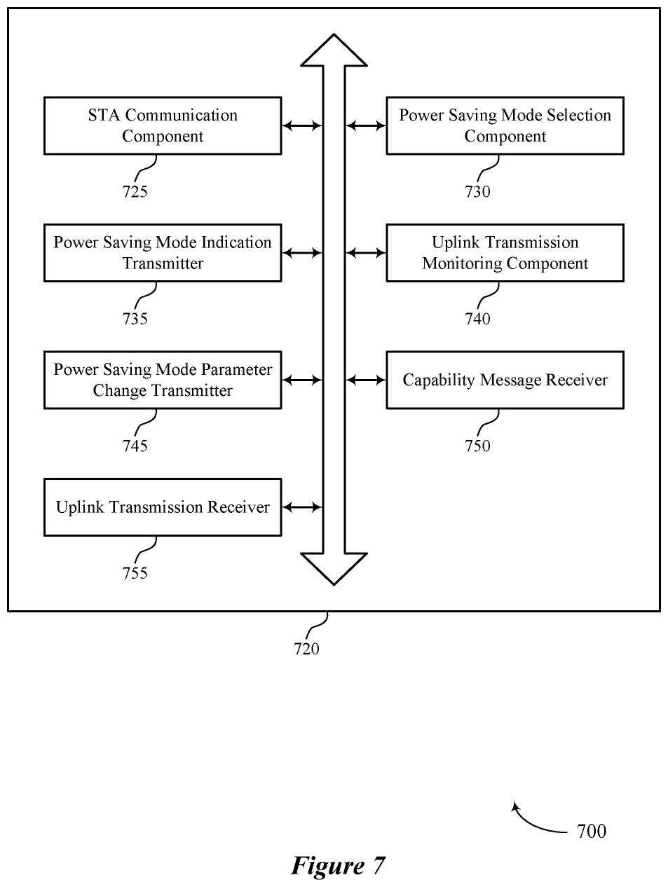

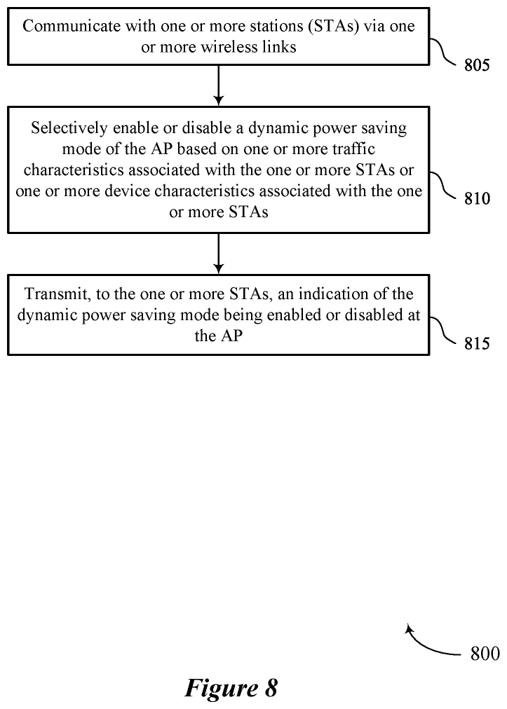

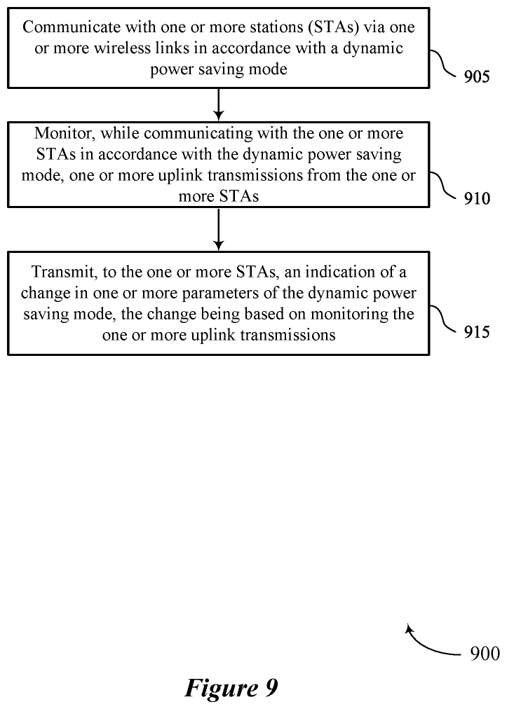

Thus, the AP 102 may utilize a power saving mode to reduce the power consumption at the AP 102 while refraining from impacting the communications with the one or more STAs 104 connected to the AP 102. Further descriptions of the techniques of the present disclosure enabling the AP 102 to dynamically or semi-statically enable or disable a power saving mode at the AP 102 to provide for more efficient utilization of computational resources thus resulting in an increase in efficiency and reliability may be described elsewhere herein, such as with refence to FIG. 7. Additionally, or alternatively, the techniques of the present disclosure may enable the AP 102 to dynamically adapt the power saving mode at the AP 102 based on monitoring the reception of uplink transmissions within the listen mode 302, the active mode 304, or both may be described elsewhere herein, such as with reference to FIGS. 8 and 9.

FIG. 4 shows an example of a process flow 400 that supports dynamic power saving mode adaptations for wireless access points. In some examples, the process flow 400 may implement or be implemented by the wireless communication network 100, the signaling diagram 200, the signaling timeline 300, or any combination thereof. For example, the process flow 400 may include an AP 102 and a STA 104 which may examples of devices described herein with reference to FIG. 1. In the following description of the process flow 400, the operations between the AP 102 and the STA 104 may be performed in different orders or at different times. Some operations also may be left out of the process flow 400, or other operations may be added. Although the AP 102 and the STA 104 are shown performing the operations of the process flow 400, some aspects of some operations also may be performed by one or more other wireless devices.

At 402, the AP 102 may communicate with one or more STAs 104 via one or more wireless links. In some implementations, at 404, the AP 102 may receive, from the one or more STAs 104, one or more capability messages associated with the one or more STAs 104. In some other implementations, the one or more capability messages may include an indication of whether each STA 104 is capable of supporting the dynamic power saving mode. In some examples, the one or more capability messages may include an indication from a first STA 104 that it is unable to support the dynamic power saving mode.

At 406, the AP 102 may receive, from the one or more STAs 104, one or more uplink transmissions while the dynamic power saving mode is enabled or disabled at the AP 102. Further, at 408, the AP 102 may monitor the one or more uplink transmissions from the one or more STAs 104. The one or more traffic characteristics may be based on monitoring the one or more uplink transmissions.

At 410, the AP 102 may selectively enable or disable a dynamic power saving mode based on one or more traffic characteristics associated with the one or more STAs 104 or one or more device characteristics associated with the one or more STAs 104. In some examples, dynamic power saving mode of the AP 102 may be selectively enabled or disabled according to a power savings metric associated with the dynamic power saving mode based on the one or more traffic characteristics or the one or more device characteristics. Moreover, the dynamic power saving mode of the AP 102 may be selectively enabled or disabled based on the power savings metric associated with the dynamic power saving mode satisfying a threshold value. Further, the one or more traffic characteristics may include one or more of an average arrival time associated with communications between the AP 102 and the one or more STAs 104, an average buffer size associated with communications between the AP 102 and the one or more STAs 104, a type of traffic associated with communications between the AP 102 and the one or more STAs 104, or any combination thereof. Moreover, the dynamic power saving mode of the AP 102 may be further selectively enabled or disabled based on a quantity of STAs 104 associated with a first traffic characteristic of the one or more traffic characteristics satisfying a threshold quantity.

In some examples, the AP 102 may selectively enable or disable the dynamic power saving mode based on the one or more capability messages. In some other cases, the AP 102 may selectively enable or disable the dynamic power saving mode based on the one or more capability messages indicating that each STA 104 is capable of supporting the dynamic power saving mode. In another case, the AP 102 may selectively enable or disable the dynamic power saving mode based on whether AP 102 is capable of supporting multi-link operations with the first STA 104 that is unable to support the dynamic power saving mode and with a second STA 104 that is capable of supporting the dynamic power saving mode. Additionally, or alternatively, the one or more traffic characteristics used to selectively enable or disable the dynamic power saving mode at AP 102 may correspond with the one or more uplink transmissions. Thus, at 412, AP 102 may transmit, to the one or more STAs 104, an indication of the dynamic power saving mode being enabled or disabled at the AP 102.

FIG. 5 shows an example of a signaling timeline 500 that supports dynamic power saving mode adaptations for wireless access points. In some examples, the signaling timeline 500 illustrates communications between an AP 102 and a STA 104 as illustrated by and described with reference to FIG. 1. For example, the signaling timeline 500 may illustrate communications between the AP 102 and the STA 104 over a duration or period of time to determine whether to adapt a listen mode 502 of a power saving mode at the AP 102 by monitoring the transmissions received with in the listen mode 502 of the power saving mode, an active mode 504 of the power saving mode, or both.

In some implementations, an AP 102 may implement or utilize a power saving mode that includes a listen mode 502 and an active mode 504 as describe elsewhere herein, such as with reference to FIG. 2. As part of the power saving mode, when the AP 102 is in the listen mode 502, the STAs 104 may transmit a control message 506 to the AP 102 that includes a wake-up indication. In response, the AP 102 may transition from the listen mode 502 to the active mode 504 of the power saving mode and transmit a control message response 508 to the STAs 104 indicating that the transition is complete. Based on receiving the control message response 508, the STAs 104 may transmit an uplink packet 510 to the AP 102. In some implementations, the STAs 104 may transmit the control message 506 to indicate for the AP 102 to switch from the listen mode 502 to the active mode 504 of the power saving mode based on the AP 102 being unable to receive the uplink packet 510 while operating in the listen mode 502 of the power saving mode.

In accordance with the techniques of the present disclosure, the AP 102 may dynamically adapt the capabilities of the listen mode 502 of th power saving mode based on monitoring the uplink traffic from the STAs 104 when the AP 102 is in the listen mode 502, the active mode 504, or both. For example, the AP 102 may dynamically adapt the reception capabilities of the listen mode 502 based on monitoring STA 104 packet statistics in the active mode 504 of the power saving mode. As described elsewhere herein, in some cases, a respective STAs 104 may have a packet to transmit that the AP 102 is unable of receiving while in the listen mode 502 of the power saving mode at the AP 102. For example, the AP 102 may be limited to a subset of reception capabilities while in the listen mode 502 that indicate that the AP 102 is capable of receiving data packets that are 20 MHz or less, use a single spatial stream, that are associated with a first MCS scheme (such as MCS 7), or any combination thereof. Therefore, if a STA 104 has a 40 MHz data packet, a 20 MHz double spatial stream data packet, a 20 MHz data packet associated with a second MCS scheme that is unsupported by the first MCS scheme (such as MCS 11), or any combination thereof, the STA 104 may transmit the control message 506 that includes a wake-up indication to trigger the AP 102 to switch to the active mode 504 of the power saving mode.

In some implementations, the AP 102 may monitor and track the bandwidth, quantity of spatial streams, MCS, PHY mode, or any combination thereof of each data packet received from a STA 104 while in the active mode 504 (such as after being woken-up by the STAs 104 via the control message 506). For example, the capabilities of the listen mode 502 may be 20 MHz, a single spatial stream, MCS 7, and HT and the capabilities of the active mode 504 may be 320 MHz, four spatial streams, MCS 13, and UHR. Therefore, if the STA 104 has a 80n MHz, single spatial stream, MCS 9, HT uplink packet (such as the uplink packet 510) to transmit, the STA 104 may transmit the control message 506 to have the AP 102 switch from the listen mode 502 to the active mode 504 of the power saving mode. In such implementations, the AP 102 may calculate the statistics of the bandwidth, quantity of spatial streams, MCS, PHY mode, or any combination thereof received from each STA 104 within a fixed or sliding observation window. Based on the calculations, the AP 102 may determine a set of candidate limited reception capability modes for the listen mode 502, LMⱼ. For example, a first candidate limited reception capability mode may be 20 MHz, 1 spatial stream, MCS 7, and HT (such as LM₁=(20 MHz, 1 ss, MCS 7, HT)), a second candidate limited reception capability mode may be 40 MHz, 2 spatial streams, MCS 7, and HT (such as LM₂=(40 MHz, 2 ss, MCS 7, HT)), and a third candidate limited reception capability mode may be 80 MHz, 2 spatial streams, MCS 11, and high efficiency (HE) (such as LM₃=(80 MHz, 2 ss, MCS 11, HE)).

To determine which limited reception capability mode candidate to use for the listen mode 502, the AP 102 may calculate a utility function, as shown in Equation 2, based on the power saving benefit of an initial limited reception capability, LMᵢₙᵢₜ, the candidate limited reception capabilities modes, LMⱼ, and the associated overhead related to switching from a respective listen mode 502 and the active mode 504 for all the candidate limited reception capabilities modes, ∀₁.

$$Utility ( L {M}_{j} ) = α ( P S B ( L {M}_{j} ) - P S B ( L {M}_{init} ) ) - β ( O {H}_{{LM}_{j}} - O {H}_{{LM}_{init}} ) {∀}_{j} \qquad ( 2 )$$

As shown above in Equation 2, the AP 102 may calculate a power saving benefit of the initial limited reception capability, LMᵢₙᵢₜ, over the power saving benefit of a respective capability limited reception capability mode, LMⱼ, in mW. Further, the AP 102 may calculate the overhead, in ms, associated with the respective candidate limited reception capability mode, OH_{LM}_{ⱼ}, over the overhead associated with the initial limited reception capability mode, OH_{LM}_{ᵢₙᵢₜ}. Moreover, the AP 102 may calculate such utility shown in Equation 2 for each candidate limited reception capability mode available at the AP 102. In some examples, when calculating the utility of a respective candidate limited reception capability mode, when LMⱼ corresponds to a capability mode with relatively higher reception capabilities than the initial limited reception capability mode, the PSB(LMⱼ) may be relatively smaller than the PSB(LBᵢₙᵢₜ). Moreover, in such examples, the OH_{LM}_{ⱼ} may be less than or equal to the OH_{LM}_{ᵢₙᵢₜ} due to a relatively smaller quantity of STAs 104 requesting the full reception capabilities (such as the active mode 504) of the AP 102. Therefore, is such examples, a relatively larger quantity of STAs 104 connected to the AP 102 may be capable of transmitting uplink packets (such as the uplink packet 510) within the listen mode 502. Thus, the STAs 104 refrain from transmitting the control message 506 to have the AP 102 switch from the listen mode 502 to the active mode 504 of the power saving mode.

In some implementations, based on the utility calculations, the AP 102 may adapt an updated listen mode 512 of the power saving mode. For example, the AP 102 may determine that if any of the respective candidate listen modes, LMⱼ, provide a utility above a threshold (such as Utility(LMⱼ)>threshold) the 102 may update the listen mode 502 to the updated listen mode 512 to support the respective candidate limited reception capability mode. In some examples, the AP 102 transmit an indication of the updated listen mode 512 to the STAs 104 via a beacons or other broadcast management frames. Moreover, the threshold may be used such that the AP 102 may experience at least a minimum benefit when switching listen modes 502 to avoid unnecessary listen mode 502 switches with relatively minimal benefit due to an additional management frame overhead associated with switching listen modes 502. For example, the AP 102 may set the threshold to a respective power saving benefit that may result in increased efficiency and reduced latency in a wireless communications network.

In some examples, if the utility of multiple candidate listen modes 502 satisfy the threshold utility, the AP 102 may select the respective candidate listen mode 502 associated with the greatest utility. Moreover, if the utility of multiple candidate listen modes 502 satisfy the threshold utility and have the same utility value, the AP 102 may select a respective candidate listen mode 502 for the updated listen mode 512 based on overhead, or the AP 102 may select the respective candidate listen mode 502 randomly. Additionally, or alternatively, the AP 102 also may select a respective candidate listen mode 502 that reduces the reception capabilities of the initial listen mode 502. For example, if the AP 102 receives a relatively low quantity of control messages 506 indicating for the AP 102 to switch from the listen mode 502 to the active mode 504, the AP 102 may be capable of further increasing the power savings by reducing the reception capabilities of the listen mode 502.

In some other implementations, the AP 102 may dynamically change the listen mode 502 (such as change the reception capabilities of the listen mode 502) based on a packet error rate (PER) from the STAs 104 in the listen mode 502. Therefore, the AP 102 may monitor the PER during the listen mode 502 to determine if the AP 102 should update the reception capabilities of the listen mode 502. For example, during the listen mode 502, the AP 102 may reduce a quantity of reception chains being utilized (such as a 4×4 AP 102 may announce or broadcast a single or double spatial stream as the limited reception capability mode of the listen mode 502). Moreover, for devices (such as STAs 104) where the limited reception capabilities of the listen mode 502 are sufficient from a traffic perspective, if the devices are a relatively large distance from the AP 102, the devices may benefit from the AP 102 using an increasing quantity of receive chains. In some examples, the AP 102 also may monitor the PER for the received data packets in the listen mode 502 to determine if the AP 102 is capable of decreasing the quantity of receive chains being used to increase the power savings or if the AP 102 should increase the quantity of receive chains to reduce the PER and increase the reliability of the AP 102 while in the listen mode 502 and using a limited capability mode. Thus, in accordance with the techniques of the present disclosure, the AP 102 may be capable of adjusting the listen mode 502 of the power saving mode based on monitoring transmissions received in the listen mode 502, the active mode 504, or both to increase the efficiency of the power saving mode and increase the power saving benefit of the listen mode 502 of the power saving mode. Further descriptions of the techniques of the present disclosure may be described elsewhere herein, such as with reference to FIG. 6.

FIG. 6 shows an example of a process flow 600 that supports dynamic power saving mode adaptations for wireless access points. In some examples, the process flow 600 may implement or be implemented by the wireless communication network 100, the signaling diagram 200, the signaling timeline 500, or any combination thereof. For example, the process flow 600 may include an AP 102 and a STA 104 which may examples of devices described herein with reference to FIG. 1. In the following description of the process flow 600, the operations between the AP 102 and the STA 104 may be performed in different orders or at different times. Some operations also may be left out of the process flow 600, or other operations may be added. Although the AP 102 and the STA 104 are shown performing the operations of the process flow 600, some aspects of some operations also may be performed by one or more other wireless devices.

At 602, the AP 102 may communicate with one or more STAs 104 via one or more wireless links in accordance with a dynamic power saving mode. In some examples, at 604, while in a listen mode of the dynamic power saving mode, the AP 102 may receive, from the one or more STAs 104, one or more uplink transmissions. Monitoring the one or more uplink transmissions may be based on the AP 102 being in the listen mode of the dynamic power saving mode.

At 606, while communicating with the one or more STAs 104 in accordance with the dynamic power saving mode, the AP 102 may monitor one or more uplink transmissions from the one or more STAs 104. At 608, monitoring the one or more uplink transmissions may include monitoring a packet error rate of the one or more uplink transmissions received while in the listen mode of the dynamic power saving mode. At 610, while in an active mode of the dynamic power saving mode, the AP 102 may receive, from the one or more STAs 104, the one or more uplink transmissions. Monitoring the one or more uplink transmissions may be based on the AP 102 being in the active mode of the dynamic power saving mode. In some examples, monitoring the one or more uplink transmissions may include monitoring one or more parameters of the one or more uplink transmissions that are received while in the active mode of the dynamic power saving mode.

At 612, the AP 102 may select a respective parameter set from one or more parameter sets for the dynamic power saving mode based on a power savings metric for each parameter set of the one or more parameter sets. In some other cases, selecting the respective parameter set for the dynamic power saving mode from the one or more parameter sets may be based on the power savings metric for the respective parameter set satisfying a threshold value.

At 614, the AP 102 may transmit, to the one or more STAs 104, an indication of a change in one or more parameters of the dynamic power saving mode. The change may be based on monitoring the one or more uplink transmissions. In some examples, transmitting the indication of the change in the one or more parameters of the dynamic power saving mode may be based on an average packet error rate of the one or more uplink transmissions received while in the listen mode of the dynamic power saving mode satisfying a packet error rate threshold. In some other examples, the indication of the change in the one or more parameters of the dynamic power saving mode may be based on selecting the respective parameter set from the one or more parameter sets. Additionally, or alternatively, the change of the one or more parameters of the dynamic power saving mode may include a change in a quantity of receive chains, a change in a bandwidth, a change in a modulation and coding scheme, a change in a quantity of spatial streams, a change in a physical layer mode, or any combination thereof for a listen mode of the dynamic power saving mode.

FIG. 7 shows a block diagram of an example wireless communication device 700 that supports dynamic power saving mode adaptations for wireless access points. In some examples, the wireless communication device 700 is configured to perform the processes 800 and 900 described with reference to FIGS. 8 and 9, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a STA communication component 725, a power saving mode selection component 730, a power saving mode indication transmitter 735, an uplink transmission monitoring component 740, a power saving mode parameter change transmitter 745, a capability message receiver 750, and an uplink transmission receiver 755. Portions of one or more of the STA communication component 725, the power saving mode selection component 730, the power saving mode indication transmitter 735, the uplink transmission monitoring component 740, the power saving mode parameter change transmitter 745, the capability message receiver 750, and the uplink transmission receiver 755 may be implemented at least in part in hardware or firmware. For example, one or more of the STA communication component 725, the power saving mode selection component 730, the power saving mode indication transmitter 735, the uplink transmission monitoring component 740, the power saving mode parameter change transmitter 745, the capability message receiver 750, and the uplink transmission receiver 755 may be implemented at least in part by at least a processor or a modem. In some examples, portions of one or more of the STA communication component 725, the power saving mode selection component 730, the power saving mode indication transmitter 735, the uplink transmission monitoring component 740, the power saving mode parameter change transmitter 745, the capability message receiver 750, and the uplink transmission receiver 755 may be implemented at least in part by a processor and software in the form of processor-executable code stored in memory.

The STA communication component 725 is configurable or configured to communicate with one or more stations (STAs) via one or more wireless links. The power saving mode selection component 730 is configurable or configured to selectively enable or disable a dynamic power saving mode of the AP based on one or more traffic characteristics associated with the one or more STAs or one or more device characteristics associated with the one or more STAs. The power saving mode indication transmitter 735 is configurable or configured to transmit, to the one or more STAs, an indication of the dynamic power saving mode being enabled or disabled at the AP.

In some examples, the uplink transmission monitoring component 740 is configurable or configured to monitor one or more uplink transmissions from the one or more STAs, where the one or more traffic characteristics are based on monitoring the one or more uplink transmissions.

In some examples, to support selectively enabling or disabling the dynamic power saving mode of the AP, the power saving mode selection component 730 is configurable or configured to selectively enable or disable the dynamic power saving mode according to a power savings metric associated with the dynamic power saving mode based on the one or more traffic characteristics or the one or more device characteristics.

In some examples, the dynamic power saving mode of the AP is selectively enabled or disabled based on the power savings metric associated with the dynamic power saving mode satisfying a threshold value.

In some examples, an average arrival time associated with communications between the AP and the one or more STAs, an average buffer size associated with communications between the AP and the one or more STAs, a type of traffic associated with communications between the AP and the one or more STAs, or any combination thereof.

In some examples, selectively enabling or disabling the dynamic power saving mode of the AP is further based on a quantity of STAs associated with a first traffic characteristic of the one or more traffic characteristics satisfying a threshold quantity.

In some examples, the capability message receiver 750 is configurable or configured to receive, from the one or more STAs, one or more capability messages associated with the one or more STAs, where selectively enabling or disabling the dynamic power saving mode of the AP is further based on the one or more capability messages.

In some examples, to support receiving the one or more capability messages, the capability message receiver 750 is configurable or configured to receive, via the one or more capability messages from the one or more STAs, an indication of whether each STA of the one or more STAs is capable of supporting the dynamic power saving mode, where selectively enabling or disabling the dynamic power saving mode of the AP is further based on the one or more capability messages indicating that each STA of the one or more STAs are capable of supporting the dynamic power saving mode.

In some examples, to support receiving the one or more capability messages, the capability message receiver 750 is configurable or configured to receive, a first STA of the one or more STAs, an indication that the first STA is unable to support the dynamic power saving mode, where selectively enabling or disabling the dynamic power saving mode of the AP is based on whether the AP is capable of supporting multi-link operations with the first STA that is unable to support the dynamic power saving mode and with a second STA of the one or more STAs that is capable of supporting the dynamic power saving mode.

In some examples, the STA communication component 725 is configurable or configured to communicate with one or more stations (STAs) via one or more wireless links in accordance with a dynamic power saving mode. The uplink transmission monitoring component 740 is configurable or configured to monitor, while communicating with the one or more STAs in accordance with the dynamic power saving mode, one or more uplink transmissions from the one or more STAs. The power saving mode parameter change transmitter 745 is configurable or configured to transmit, to the one or more STAs, an indication of a change in one or more parameters of the dynamic power saving mode, the change being based on monitoring the one or more uplink transmissions.

In some examples, the uplink transmission receiver 755 is configurable or configured to receive, while in an active mode of the dynamic power saving mode, the one or more uplink transmissions from the one or more STAs, where monitoring the one or more uplink transmissions is based on the AP being in the active mode of the dynamic power saving mode.

In some examples, to support monitoring the one or more uplink transmissions, the uplink transmission monitoring component 740 is configurable or configured to monitor a mode of the one or more uplink transmissions that are received while in the active mode of the dynamic power saving mode.

In some examples, the power saving mode parameter change transmitter 745 is configurable or configured to select a respective parameter set from one or more parameter sets for the dynamic power saving mode based on a power savings metric for each parameter set of the one or more parameter sets, where the indication of the change in the one or more parameters of the dynamic power saving mode is based on selecting the respective parameter set from the one or more parameter sets.

In some examples, selecting the respective parameter set for the dynamic power saving mode from the one or more parameter sets is based on the power savings metric for the respective parameter set satisfying a threshold value.

In some examples, the uplink transmission receiver 755 is configurable or configured to receive, while in a listen mode of the dynamic power saving mode, the one or more uplink transmissions from the one or more STAs, where monitoring the one or more uplink transmissions is based on the AP being in the listen mode of the dynamic power saving mode.

In some examples, to support monitoring the one or more uplink transmissions, the uplink transmission monitoring component 740 is configurable or configured to monitor a packet error rate of the one or more uplink transmissions received while in the listen mode of the dynamic power saving mode.

In some examples, transmitting the indication of the change of in the one or more parameters of the dynamic power saving mode is based on an average packet error rate of the one or more uplink transmissions received while in the listen mode of the dynamic power saving mode satisfying a packet error rate threshold.

In some examples, the change of the one or more parameters of the dynamic power saving mode includes a change in a quantity of receive chains, a change in a bandwidth, a change in a modulation and coding scheme, a change in a quantity of spatial streams, a change in a physical layer mode, or any combination thereof for a listen mode of the dynamic power saving mode.

FIG. 8 shows a flowchart illustrating an example process 800 performable by or at an AP that supports dynamic power saving mode adaptations for wireless access points. The operations of the process 800 may be implemented by an AP or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the AP may communicate with one or more stations (STAs) via one or more wireless links. The operations of 805 may be performed in accordance with examples as disclosed herein. In some implementations, aspects of the operations of 805 may be performed by a STA communication component 725 as described with reference to FIG. 7.

In some examples, in 810, the AP may selectively enable or disable a dynamic power saving mode of the AP based on one or more traffic characteristics associated with the one or more STAs or one or more device characteristics associated with the one or more STAs. The operations of 810 may be performed in accordance with examples as disclosed herein. In some implementations, aspects of the operations of 810 may be performed by a power saving mode selection component 730 as described with reference to FIG. 7.

In some examples, in 815, the AP may transmit, to the one or more STAs, an indication of the dynamic power saving mode being enabled or disabled at the AP. The operations of 815 may be performed in accordance with examples as disclosed herein. In some implementations, aspects of the operations of 815 may be performed by a power saving mode indication transmitter 735 as described with reference to FIG. 7.

FIG. 9 shows a flowchart illustrating an example process 900 performable by or at an AP that supports dynamic power saving mode adaptations for wireless access points. The operations of the process 900 may be implemented by an AP or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 905, the AP may communicate with one or more stations (STAs) via one or more wireless links in accordance with a dynamic power saving mode. The operations of 905 may be performed in accordance with examples as disclosed herein. In some implementations, aspects of the operations of 905 may be performed by a STA communication component 725 as described with reference to FIG. 7.

In some examples, in 910, the AP may monitor, while communicating with the one or more STAs in accordance with the dynamic power saving mode, one or more uplink transmissions from the one or more STAs. The operations of 910 may be performed in accordance with examples as disclosed herein. In some implementations, aspects of the operations of 910 may be performed by an uplink transmission monitoring component 740 as described with reference to FIG. 7.

In some examples, in 915, the AP may transmit, to the one or more STAs, an indication of a change in one or more parameters of the dynamic power saving mode, the change being based on monitoring the one or more uplink transmissions. The operations of 915 may be performed in accordance with examples as disclosed herein. In some implementations, aspects of the operations of 915 may be performed by a power saving mode parameter change transmitter 745 as described with reference to FIG. 7.

Implementation examples are described in the following numbered clauses:

The following provides an overview of aspects of the present disclosure:

Aspect 1: A method for wireless communications by an AP, comprising: communicating with one or more STAs via one or more wireless links; selectively enabling or disabling a dynamic power saving mode of the AP based at least in part on one or more traffic characteristics associated with the one or more STAs or one or more device characteristics associated with the one or more STAs; and transmitting, to the one or more STAs, an indication of the dynamic power saving mode being enabled or disabled at the AP.

Aspect 2: The method of aspect 1, further comprising: monitoring one or more uplink transmissions from the one or more STAs, wherein the one or more traffic characteristics are based at least in part on monitoring the one or more uplink transmissions.

Aspect 3: The method of any of aspects 1 through 2, wherein selectively enabling or disabling the dynamic power saving mode of the AP comprises: selectively enabling or disabling the dynamic power saving mode according to a power savings metric associated with the dynamic power saving mode based at least in part on the one or more traffic characteristics or the one or more device characteristics.

Aspect 4: The method of aspect 3, wherein the dynamic power saving mode of the AP is selectively enabled or disabled based at least in part on the power savings metric associated with the dynamic power saving mode satisfying a threshold value.

Aspect 5: The method of any of aspects 1 through 4, wherein the one or more traffic characteristics include one or more of an average arrival time associated with communications between the AP and the one or more STAs, an average buffer size associated with communications between the AP and the one or more STAs, a type of traffic associated with communications between the AP and the one or more STAs, or any combination thereof.

Aspect 6: The method of any of aspects 1 through 5, wherein selectively enabling or disabling the dynamic power saving mode of the AP is further based at least in part on a quantity of STAs associated with a first traffic characteristic of the one or more traffic characteristics satisfying a threshold quantity.

Aspect 7: The method of any of aspects 1 through 6, further comprising: receiving, from the one or more STAs, one or more capability messages associated with the one or more STAs, wherein selectively enabling or disabling the dynamic power saving mode of the AP is further based at least in part on the one or more capability messages.

Aspect 8: The method of aspect 7, wherein receiving the one or more capability messages comprises: receiving, via the one or more capability messages from the one or more STAs, an indication of whether each STA of the one or more STAs is capable of supporting the dynamic power saving mode, wherein selectively enabling or disabling the dynamic power saving mode of the AP is further based at least in part on the one or more capability messages indicating that each STA of the one or more STAs are capable of supporting the dynamic power saving mode.

Aspect 9: The method of any of aspects 7 through 8, wherein receiving the one or more capability messages comprises: receiving, a first STA of the one or more STAs, an indication that the first STA is unable to support the dynamic power saving mode, wherein selectively enabling or disabling the dynamic power saving mode of the AP is based at least in part on whether the AP is capable of supporting multi-link operations with the first STA that is unable to support the dynamic power saving mode and with a second STA of the one or more STAs that is capable of supporting the dynamic power saving mode.

Aspect 10: A method for wireless communications by an AP, comprising: communicating with one or more STAs via one or more wireless links in accordance with a dynamic power saving mode; monitoring, while communicating with the one or more STAs in accordance with the dynamic power saving mode, one or more uplink transmissions from the one or more STAs; and transmitting, to the one or more STAs, an indication of a change in one or more parameters of the dynamic power saving mode, the change being based at least in part on monitoring the one or more uplink transmissions.

Aspect 11: The method of aspect 10, further comprising: receiving, while in an active mode of the dynamic power saving mode, the one or more uplink transmissions from the one or more STAs, wherein monitoring the one or more uplink transmissions is based at least in part on the AP being in the active mode of the dynamic power saving mode.

Aspect 12: The method of aspect 11, wherein monitoring the one or more uplink transmissions comprises: monitoring a mode of the one or more uplink transmissions that are received while in the active mode of the dynamic power saving mode.

Aspect 13: The method of any of aspects 11 through 12, further comprising: selecting a respective parameter set from one or more parameter sets for the dynamic power saving mode based at least in part on a power savings metric for each parameter set of the one or more parameter sets, wherein the indication of the change in the one or more parameters of the dynamic power saving mode is based at least in part on selecting the respective parameter set from the one or more parameter sets.

Aspect 14: The method of aspect 13, wherein selecting the respective parameter set for the dynamic power saving mode from the one or more parameter sets is based at least in part on the power savings metric for the respective parameter set satisfying a threshold value.

Aspect 15: The method of any of aspects 10 through 14, further comprising: receiving, while in a listen mode of the dynamic power saving mode, the one or more uplink transmissions from the one or more STAs, wherein monitoring the one or more uplink transmissions is based at least in part on the AP being in the listen mode of the dynamic power saving mode.

Aspect 16: The method of aspect 15, wherein monitoring the one or more uplink transmissions comprises: monitoring a packet error rate of the one or more uplink transmissions received while in the listen mode of the dynamic power saving mode.

Aspect 17: The method of aspect 16, wherein transmitting the indication of the change of in the one or more parameters of the dynamic power saving mode is based at least in part on an average packet error rate of the one or more uplink transmissions received while in the listen mode of the dynamic power saving mode satisfying a packet error rate threshold.

Aspect 18: The method of any of aspects 10 through 17, wherein the change of the one or more parameters of the dynamic power saving mode comprises a change in a quantity of receive chains, a change in a bandwidth, a change in a modulation and coding scheme, a change in a quantity of spatial streams, a change in a physical layer mode, or any combination thereof for a listen mode of the dynamic power saving mode.

Aspect 19: An AP comprising one or more memories storing processor-executable code, and one or more processors coupled with the one or more memories and individually or collectively operable to execute the code to cause the AP to perform a method of any of aspects 1 through 9.

Aspect 20: An AP comprising at least one means for performing a method of any of aspects 1 through 9.

Aspect 21: A non-transitory computer-readable medium storing code the code comprising instructions executable by one or more processors to perform a method of any of aspects 1 through 9.

Aspect 22: An AP comprising one or more memories storing processor-executable code, and one or more processors coupled with the one or more memories and individually or collectively operable to execute the code to cause the AP to perform a method of any of aspects 10 through 18.

Aspect 23: An AP comprising at least one means for performing a method of any of aspects 10 through 18.

Aspect 24: A non-transitory computer-readable medium storing code the code comprising instructions executable by one or more processors to perform a method of any of aspects 10 through 18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An access point (AP), comprising:
a processing system that includes processor circuitry and memory circuitry that stores code, the processing system configured to cause the AP to:
communicate with one or more stations (STAs) via one or more wireless links;
selectively enable or disable a dynamic power saving mode of the AP based at least in part on one or more traffic characteristics associated with the one or more STAs or one or more device characteristics associated with the one or more STAs; and
transmit, to the one or more STAs, an indication of the dynamic power saving mode being enabled or disabled at the AP.

2. The AP of claim 1, wherein the processing system is further configured to cause the AP to:
monitor one or more uplink transmissions from the one or more STAs, wherein the one or more traffic characteristics are based at least in part on monitoring the one or more uplink transmissions.

3. The AP of claim 1, wherein, to selectively enable or disable the dynamic power saving mode of the AP, the processing system is configured to cause the AP to:
selectively enable or disable the dynamic power saving mode according to a power savings metric associated with the dynamic power saving mode based at least in part on the one or more traffic characteristics or the one or more device characteristics.

4. The AP of claim 3, wherein the dynamic power saving mode of the AP is selectively enabled or disabled based at least in part on the power savings metric associated with the dynamic power saving mode satisfying a threshold value.

5. The AP of claim 1, wherein an average inter-arrival time associated with communications between the AP and the one or more STAs, an average buffer size associated with communications between the AP and the one or more STAs, a type of traffic associated with communications between the AP and the one or more STAs, or any combination thereof.

6. The AP of claim 1, wherein selectively enabling or disabling the dynamic power saving mode of the AP is further based at least in part on a quantity of STAs associated with a first traffic characteristic of the one or more traffic characteristics satisfying a threshold quantity.

7. The AP of claim 1, wherein the processing system is further configured to cause the AP to:
receive, from the one or more STAs, one or more capability messages associated with the one or more STAs, wherein selectively enabling or disabling the dynamic power saving mode of the AP is further based at least in part on the one or more capability messages.

8. The AP of claim 7, wherein, to receive the one or more capability messages, the processing system is configured to cause the AP to:
receive, via the one or more capability messages from the one or more STAs, an indication of whether each STA of the one or more STAs is capable of supporting the dynamic power saving mode, wherein selectively enabling or disabling the dynamic power saving mode of the AP is further based at least in part on the one or more capability messages indicating that each STA of the one or more STAs are capable of supporting the dynamic power saving mode.

9. The AP of claim 7, wherein, to receive the one or more capability messages, the processing system is configured to cause the AP to:
receive, from a first STA of the one or more STAs, an indication that the first STA is unable to support the dynamic power saving mode, wherein selectively enabling or disabling the dynamic power saving mode of the AP is based at least in part on whether the AP is capable of supporting multi-link operations with the first STA that is unable to support the dynamic power saving mode and with a second STA of the one or more STAs that is capable of supporting the dynamic power saving mode.

10. An access point (AP), comprising:
a processing system that includes processor circuitry and memory circuitry that stores code, the processing system configured to cause the AP to:
communicate with one or more stations (STAs) via one or more wireless links in accordance with a dynamic power saving mode;
monitor, while communicating with the one or more STAs in accordance with the dynamic power saving mode, one or more uplink transmissions from the one or more STAs; and
transmit, to the one or more STAs, an indication of a change in one or more parameters of the dynamic power saving mode, the change being based at least in part on monitoring the one or more uplink transmissions.

11. The AP of claim 10, wherein the processing system is further configured to cause the AP to:
receive, while in an active mode of the dynamic power saving mode, the one or more uplink transmissions from the one or more STAs, wherein monitoring the one or more uplink transmissions is based at least in part on the AP being in the active mode of the dynamic power saving mode.

12. The AP of claim 11, wherein, to monitor the one or more uplink transmissions, the processing system is configured to cause the AP to:
monitor one or more parameters of the one or more uplink transmissions that are received while in the active mode of the dynamic power saving mode.

13. The AP of claim 11, wherein the processing system is further configured to cause the AP to:
select a respective parameter set from one or more parameter sets for the dynamic power saving mode based at least in part on a power savings metric for each parameter set of the one or more parameter sets, wherein the indication of the change in the one or more parameters of the dynamic power saving mode is based at least in part on selecting the respective parameter set from the one or more parameter sets.

14. The AP of claim 13, wherein selecting the respective parameter set for the dynamic power saving mode from the one or more parameter sets is based at least in part on the power savings metric for the respective parameter set satisfying a threshold value.

15. The AP of claim 10, wherein the processing system is further configured to cause the AP to:
receive, while in a listen mode of the dynamic power saving mode, the one or more uplink transmissions from the one or more STAs, wherein monitoring the one or more uplink transmissions is based at least in part on the AP being in the listen mode of the dynamic power saving mode.

16. The AP of claim 15, wherein, to monitor the one or more uplink transmissions, the processing system is configured to cause the AP to:
monitor a packet error rate of the one or more uplink transmissions received while in the listen mode of the dynamic power saving mode.

17. The AP of claim 16, wherein transmitting the indication of the change of the one or more parameters of the dynamic power saving mode is based at least in part on an average packet error rate of the one or more uplink transmissions received while in the listen mode of the dynamic power saving mode satisfying a packet error rate threshold.

18. The AP of claim 10, wherein the change of the one or more parameters of the dynamic power saving mode comprises a change in a quantity of receive chains, a change in a bandwidth, a change in a modulation and coding scheme, a change in a quantity of spatial streams, a change in a physical layer mode, or any combination thereof for a listen mode of the dynamic power saving mode.

19. A method for wireless communications by an access point (AP), comprising:
communicating with one or more stations (STAs) via one or more wireless links;
selectively enabling or disabling a dynamic power saving mode of the AP based at least in part on one or more traffic characteristics associated with the one or more STAs or one or more device characteristics associated with the one or more STAs; and
transmitting, to the one or more STAs, an indication of the dynamic power saving mode being enabled or disabled at the AP.

20. The method of claim 19, further comprising:
monitoring one or more uplink transmissions from the one or more STAs, wherein the one or more traffic characteristics are based at least in part on monitoring the one or more uplink transmissions.

21. The method of claim 19, wherein selectively enabling or disabling the dynamic power saving mode of the AP comprises:
selectively enabling or disabling the dynamic power saving mode according to a power savings metric associated with the dynamic power saving mode based at least in part on the one or more traffic characteristics or the one or more device characteristics.

22. The method of claim 19, wherein the one or more traffic characteristics include one or more of an average arrival time associated with communications between the AP and the one or more STAs, an average buffer size associated with communications between the AP and the one or more STAs, a type of traffic associated with communications between the AP and the one or more STAs, or any combination thereof.

23. The method of claim 19, wherein selectively enabling or disabling the dynamic power saving mode of the AP is further based at least in part on a quantity of STAs associated with a first traffic characteristic of the one or more traffic characteristics satisfying a threshold quantity.

24. The method of claim 19, further comprising:
receiving, from the one or more STAs, one or more capability messages associated with the one or more STAs, wherein selectively enabling or disabling the dynamic power saving mode of the AP is further based at least in part on the one or more capability messages.

25. A method for wireless communications by an access point (AP), comprising:
communicating with one or more stations (STAs) via one or more wireless links in accordance with a dynamic power saving mode;
monitoring, while communicating with the one or more STAs in accordance with the dynamic power saving mode, one or more uplink transmissions from the one or more STAs; and
transmitting, to the one or more STAs, an indication of a change in one or more parameters of the dynamic power saving mode, the change being based at least in part on monitoring the one or more uplink transmissions.

26. The method of claim 25, further comprising:
receiving, while in an active mode of the dynamic power saving mode, the one or more uplink transmissions from the one or more STAs, wherein monitoring the one or more uplink transmissions is based at least in part on the AP being in the active mode of the dynamic power saving mode.

27. The method of claim 26, wherein monitoring the one or more uplink transmissions comprises:
monitoring one or more parameters of the one or more uplink transmissions that are received while in the active mode of the dynamic power saving mode.

28. The method of claim 26, further comprising:
selecting a respective parameter set from one or more parameter sets for the dynamic power saving mode based at least in part on a power savings metric for each parameter set of the one or more parameter sets, wherein the indication of the change in the one or more parameters of the dynamic power saving mode is based at least in part on selecting the respective parameter set from the one or more parameter sets.

29. The method of claim 25, further comprising:
receiving, while in a listen mode of the dynamic power saving mode, the one or more uplink transmissions from the one or more STAs, wherein monitoring the one or more uplink transmissions is based at least in part on the AP being in the listen mode of the dynamic power saving mode.

30. The method of claim 29, wherein monitoring the one or more uplink transmissions comprises:
monitoring a packet error rate of the one or more uplink transmissions received while in the listen mode of the dynamic power saving mode.
